(19) United States
(12) Patent Application Publication
(10) Pub. No.: US 2010/0037251 A1
(43) Pub. Date: Feb. 11, 2010

(54) DISTRIBUTING INFORMATION OVER DVB-H

(75) Inventor: Leif Magnus LINDHULT, Malmo (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/189,227

(22) Filed: Aug. 11, 2008

(51) Int. Cl. H04N 7/167

(52) U.S. Cl. 725/31

(57) ABSTRACT

A method may include receiving a web feed from a content provider, aggregating the web feed with other information, and broadcasting the aggregated web feed over a digital video broadcast-handheld (DVB-H) network. The aggregated web feed may be received by a device having a digital video broadcast receiver and an initial access key for the DVB-H broadcast.

### BACKGROUND

Digital Video Broadcasting-Handheld (DVB-H), developed by the International DVB (Digital Video Broadcasting) Project, is a protocol for bringing broadcast services to mobile handsets. Conditional access techniques may be used to render DVB-H broadcast signals unusable to mobile devices that do not have keys for encryption and decryption of the signals.

### SUMMARY

In one implementation, a method may include receiving, at a device having a digital video broadcast receiver, an initial access key for a digital video broadcast-handheld (DVB-H) broadcast. The method may also include receiving a web feed file, the web feed file being provided over a DVB-H network. The method may further include decoding the web feed file based on the initial access key and displaying the web feed file on a display.

Additionally, the web feed file may include a link to a web site associated with information in the web feed file, and the method may further include accessing the link to the web site using a mobile network.

Additionally, the web feed file may include information for a television program associated with the web feed file, and the method may further include displaying the television program.

Additionally, displaying the web feed file may include presenting a user with an option to access additional information related to the web feed.

Additionally, the web feed file may include a tag, and the method may further include reading the tag on the web feed file and determining to display the web feed file based on the tag.

Additionally, the initial access key may be provided over a mobile network.

Additionally, the web feed may be an aggregated web feed file that includes web feeds from multiple content providers.

Additionally, the method may further include broadcasting the web feed file together with a television program related to the web feed file.

Additionally, the method may further include broadcasting data over the DVB-H network at a particular time period based on a request from the device, the request being provided via a mobile network connection.

In another implementation, a method may include receiving a web feed from a content provider, aggregating the web feed with information from other content providers; encrypting the aggregated web feed; and broadcasting the encrypted aggregated web feed over a digital video broadcast-handheld (DVB-H) network.

Additionally, the method may further include sending an initial access key to a subscriber's device, the initial access key including information to decrypt the encrypted aggregated web feed.

Additionally, the method may further include broadcasting a decryption key to a subscriber's device, the decryption key including information to decrypt a future encrypted aggregated web feed.

Additionally, the method may further include associating the web feed with a television program being broadcast over the DVB-H network.

Additionally, the method may further include notifying a subscriber's device of a particular time period when the aggregated web feed will be broadcast over the DVB-H network and broadcasting the aggregated web feed during the particular time.

Additionally, the method may further include receiving a subscription request for a subscriber's device to receive the aggregated web feed.

Additionally, aggregating the web feed with other information may include collecting web feeds from multiple content providers within a particular time period.

In another implementation, a device may include a digital broadcast receiver module to receive a web feed over a digital video broadcast-handheld (DVB-H) network, a web feed reader to format information in the web feed, a display to present the formatted information in the web feed to a user, and processing logic to accept a user input and to retrieve additional information related to the web feed based on the user input.

Additionally, the user input may be a selection of a web site and the additional information may be retrieved through a mobile network.

Additionally, the user input may be a selection of a television program and the addition information may be retrieved from a DVB-H broadcast.

Additionally, the web feed may be encrypted and the device may further include processing logic to decrypt the encrypted web feed based on a decryption key.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIG. 1 is a diagram illustrating an exemplary system in which concepts described herein may be implemented;

FIG. 2 is a diagram of an exemplary electronic device in which methods and systems described herein may be implemented;

FIG. 3 is a block diagram illustrating components of the electronic device of FIG. 2 according to an exemplary implementation;

FIG. 4 is functional block diagram of the electronic device of FIG. 3;

FIG. 5 is a schematic illustrating an exemplary DVB-H frame structure;

FIG. 6 is a flow diagram illustrating exemplary operations associated with broadcasting web feeds over DVB-H;

FIG. 7 is a flow diagram illustrating exemplary operations associated with receiving broadcast web feeds over DVB-H; and

FIG. 8 is an illustration of an exemplary implementation of the operations of FIG. 7.

### DETAILED DESCRIPTION

The following detailed description refers to the accompanying drawings. The same reference numbers in different drawings may identify the same or similar elements. Also, the following detailed description does not limit the invention.

### Overview

Systems and methods described herein may provide web feeds and other information to mobile electronic devices through a digital video broadcasting network, such as DVB-H. Rather than repeatedly checking for and downloading new information, a mobile electronic device may simply listen to an information channel, for example, at certain time-intervals or when a particular trigger arrives. Web feeds, web feeds with audio (e.g., podcasts), video web feeds, and/or information for use by widgets may be distributed over DVB-H, thus eliminating use of an internet connection by the mobile electronic device and taking advantage of the high bandwidth capabilities of DVB-H networks.

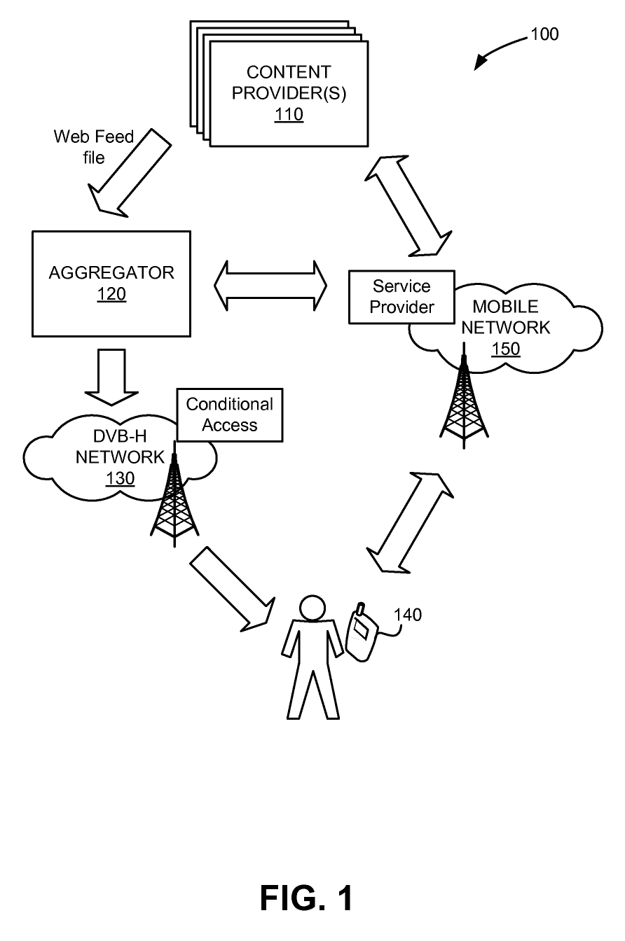

FIG. 1 is a diagram illustrating an exemplary system 100 in which concepts described herein may be implemented. As shown in FIG. 1, system 100 may include content providers 110, an aggregator 120, a DVB-H network 130, an electronic device 140, and a mobile network 150. Content provider(s) 110 may include one or more devices for providing content/information to over a network. For example, content provider(s) 110 may represent one or more computing devices. In one implementation, content provider(s) 110 may be a server device, such as a web server, that provides frequently updated content, such as news headlines, blog entries, podcasts, and the like. In another implementation, content provider(s) 110 may receive instructions from electronic device 140 and provide content on demand, such as videos, periodicals, music, etc.

Content provider(s) 110 may distribute updated content using a web feed (such as Really Simple Syndication (RSS) or Atom Syndication Format) that contains content item summaries with web links to complete versions of the content item. The web feed may be distributed as separate files from the content item. For example, the web feed may be distributed to aggregator 120 in response to a request (e.g. a periodic request) from aggregator 120, while the complete version of the content item may be distributed separately to electronic device 140 in response to a request from electronic device 140.

Aggregator 120 may include one or more devices for requesting and receiving web feeds from content provider(s) 110. Aggregator 120 may include hardware and/or software for receiving web feeds from content providers 110, formatting the information for broadcasting, and sending the formatted information via DVB-H network to electronic device 140. Aggregated files may be formatted, for example, in a multicast delivery format such as File Delivery over Unidirectional Transport (FLUTE). Aggregator 120 may also communicate with a service provider in mobile network 150 to provide initial access information to subscribers so that the subscriber devices, such as electronic device 140, can decode selected broadcasts from DVB-H network 130.

DVB-H network 130 may include one or more devices and networks that provide for multimedia broadcasting to wireless devices, such as electronic device 140. DVB-H network 130 may use the DVB-H standard for the delivery of audio and video content to mobile handheld devices. DVB-H network 130 may transmit information using internet protocol (IP) packets (also known as IP datagrams). In addition to video and audio broadcasting, IP datacasts can also be used for delivery of web feeds over DVB-H. Generally, DVB-H may incorporate time-slicing technology that lowers battery power consumption for wireless devices, such as electronic device 140, and may improve continuity in difficult reception environments. Time-slicing generally means that data for a particular service may be delivered to electronic device 140 in bursts at particular intervals of time. Thus, when electronic device 140 is not receiving a burst of data electronic device 140 can use less power.

DVB-H network 130 may include a variety of components to facilitate broadcasts of web feeds to electronic device 140. Such components may include one or more encoders, DVB-H encapsulators, DVB-H modulators and transmitters. DVB-H network 130 may also include a management component, such as a conditional access component to manage access and encryptions for DVB-H broadcasts. In one implementation, the conditional access component may provide encryption/decryption keys to subscribing electronic devices, such as electronic device 140. A variety of key-distribution techniques (both known and to be known) may be used. For example, an initial access key may be provided to a subscribing device prior to a DVB-H broadcast, while other access keys may be provided during the DVB-H broadcast. In one implementation, an initial access key to decrypt the encrypted aggregated web feed may be sent to a subscriber's device. In another implementation, the initial access key may be used to decrypt other key-streams that can later be used to decrypt the encrypted aggregated web feed. In some implementations, an access key may be preloaded on electronic device 140 or be made physically available to the device (e.g., via a subscriber identity module (SIM) card, a re-useable identification module (R-UIM), or other mechanism). In one implementation, DVB-H network 130 may broadcast web feeds on a particular channel on a continuous basis. In another implementation, DVB-H network 130 may broadcast web feeds at particular time periods, such as time periods that have been previously identified to subscribing devices.

Electronic device 140 may be a mobile device configured to receive web feeds that are broadcast over DVB-H network 130. Electronic device 140 may also be configured to request or respond to the web feeds over mobile network 150. Thus, electronic device 140 may be capable of operating within multiple types of networks. For example, electronic device 140 may be configured to operate in digital video broadcasting network according to, e.g., DVB-H technology. Also, electronic device 140 may be configured to operate using a wide area cellular telephone network according to, e.g., 3G-technology (e.g., W-CDMA or CDMA2000), 2.5-technology (e.g., GPRS), 2G-technology (e.g., GSM), or similar technology.

Mobile network 150 may generally include one or more networks that provide telephony or data services to content provider(s) 110 and/or electronic device 140. Mobile network 150 may include, for example, a cellular network and one or more networks of any type, including a Public Land Mobile Network (PLMN), a Public Switched Telephone Network (PSTN), a VOIP network, a metropolitan area network (MAN), a wide area network (WAN), a local area network (LAN), a private network, the Internet, an intranet, and/or another type of network. Where mobile network 150 particularly represents a number of different types of networks, mobile network 150 may also include gateway devices that provide interfaces between different network types.

In one implementation, using system 100, content provider(s) 110 may distribute web feeds (such as RSS XML files) to aggregator 120. Aggregator 120 may collect the web feeds and sort/combine the web feeds according to particular channels and format the aggregated web feeds for distribution over DVB-H network 130. The aggregated web feed may be encoded and broadcast to multiple devices through DVB-H network 130. In one implementation, devices with a subscription key, such as electronic device 140, may receive and decode the aggregated web feed. In another implementation, a subscription key may not be necessary for the device to receive certain web feeds. The aggregated web feed is thus received at the network device 140 without reliance on mobile network 150, and the user of mobile device 140 may selectively interact with the aggregated web feed to initiate subsequent downloads from either DVB-H network 130 or mobile network 150.

In another implementation, using system 100, content provider(s) 110 may send television programming over DVB-H network 130 (optionally bypassing aggregator 120). The programming may include an audio stream, a video stream, an optional subtitle stream, and a web feed stream. Each of the audio stream, video stream, optional subtitle stream, and web feed stream may arrive at electronic device 140 in the same frequency, but on different ports. In one implementation, the web feed stream may be provided in accordance with Session Description Protocol (SDP) as defined in the Internet Engineering Task Force (IETF) Request for Comments (RFC) 2327. Electronic device 140 may receive the web feed stream in, for example, RSS text format, and the web feed may be displayed on the electronic device 140. If interested, a user can simply push a button to begin watching the television program associated with the web feed, thus providing a user with simple access to mobile television.

In another implementation, using system 100, content provider(s) 110 may broadcast data over DVB-H network 130 at a particular time period based on a request from electronic device 140. Electronic device 140 may provide the request via mobile network 150 at a prior time. The request may include a request for a broadcast at a specific time and/or a broadcast of particular information, such as a widget information update, a podcast, a web feed update, or the like. In one implementation, content provider 110 may provide a message to electronic device 140 via mobile network 150 to indicate the particular interval when the requested information will be broadcast over DVB-H network 130 before actually broadcasting the information during the particular interval.

In a further implementation, IP packets for the web feeds broadcasted over DVB-H network 130 may include a tag or other indicator identifying the topic or source (e.g., the name of the content provider) of the web feed. Electronic device 140 may compare the tag with a web-feed listing (e.g., created by the user or based on a subscription criteria) to identify particular web feeds of interest to the user. Thus, electronic device 140 may identify only particular information within a DVB-H web feed stream to provide to the user. In one implementation, the tag may trigger electronic device 140 to immediately display the web feed to the user.

The number of content provider(s) 110, aggregators 120, DVB-H networks 130, electronic devices 140, and networks 150 illustrated in FIG. 1 is provided for simplicity. In practice, there may be more content provider(s) 110, aggregators 120, DVB-H networks 130, electronic devices 140, and/or networks 150.

### Exemplary Device

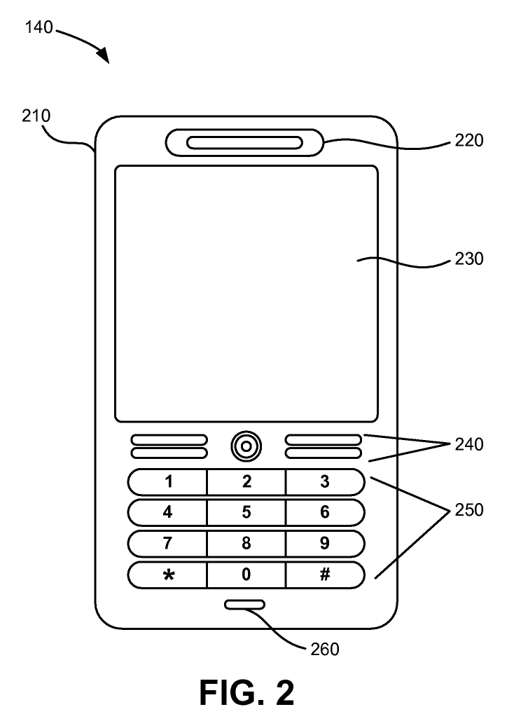

FIG. 2 is a diagram of exemplary electronic device 140 in which methods and systems described herein may be implemented. Implementations are described herein in the context of an electronic device having a display. As used herein, the term “electronic device” may include a cellular radiotelephone; a Personal Communications System (PCS) terminal that may combine a cellular radiotelephone with data processing, facsimile and data communications capabilities; a PDA that can include a radiotelephone, pager, Internet/Intranet access, and web browser; a portable gaming device; a portable media player device; a digital camera; a palmtop computer; or any other mobile device that includes a display. Electronic device 140 may also include communication, media playing, recording, and/or storing capabilities.

Referring to FIG. 2, electronic device 140 may include a housing 210, a speaker 220, a display 230, control buttons 240, a keypad 250, and a microphone 260. Housing 210 may protect the components of electronic device 140 from outside elements. Speaker 220 may provide audible information to a user of electronic device 140. Speaker 220 may include any component capable of transducing an electrical signal to a corresponding sound wave. For example, a user may listen to music or videos through speaker 220.

Display 230 may provide visual information to the user. Display 230 may include a device that can display signals generated by electronic device 140 as text or images on a screen (e.g., a liquid crystal display (LCD), cathode ray tube (CRT) display, organic light-emitting diode (OLED) display, surface-conduction eletro-emitter display (SED), plasma display, field emission display (FED), bistable display, etc.). Display 230 may provide, for example, video or still images associated with downloaded content. For example, display 230 may present images and other information received via a DVB-H receiver. As another example, buttons, icons, virtual keys, or other graphical elements may be presented via display 230. Also, display 230 may provide information associated with incoming or outgoing calls, text messages, games, phone books, the current date/time, volume settings, etc., to a user of electronic device 140. In one implementation, display 230 may also serve-in conjunction with a touch panel (not shown)-as a touch screen interface to detect user input when the user interacts with, for example, graphical elements displayed on display 230.

Control buttons 240 may also be included to permit the user to interact with electronic device 140 to cause electronic device 140 to perform one or more operations, such as play various media, access an application, place a telephone call, etc. For example, control buttons 240 may include a key enabling a user to interact with information shown on display 230. Control buttons 240 may also include a dial button, hang up button, play button, etc. One of control buttons 240 may be a menu button that permits the user to view various settings on display 230.

Keypad 250 may provide input to electronic device 140. Keypad 250 may include a standard telephone keypad or alphanumeric keypad. Keys on keypad 250 may perform multiple functions depending upon a particular application selected by the user. Microphone 260 may receive audible information from the user. Microphone 260 may include any component capable of transducing air pressure waves to a corresponding electrical signal.

The components described above with respect to electronic device 140 are not limited to those described herein. Other components, such as a connectivity ports, memory slots, and/or a camera, may be located on electronic device 140, including, for example, on a rear or side panel of housing 210.

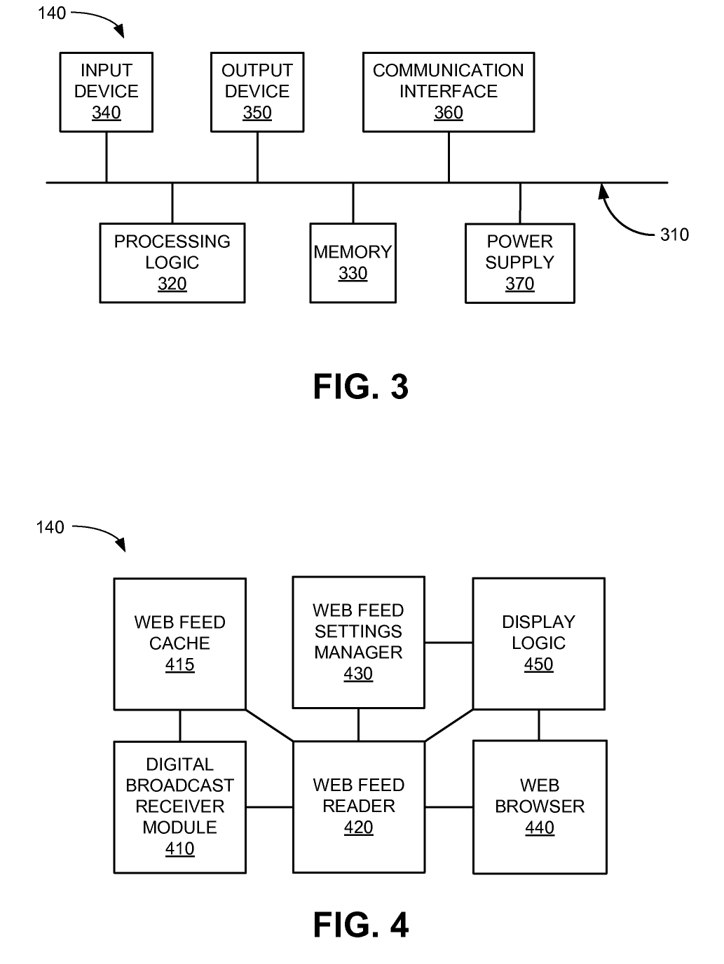

FIG. 3 is a diagram illustrating components of electronic device 140 according to an exemplary implementation. Electronic device 140 may include a bus 310, processing logic 320, a memory 330, an input device 340, an output device 350, a communication interface 360, and a power supply 370. In other implementations, electronic device 140 may be configured in a number of other ways and may include other or different components. For example, electronic device 140 may include an antenna and one or more modulators, demodulators, encoders, decoders, etc., for processing data.

Bus 310 may permit communication among the components of electronic device 140. Processing logic 320 may include a processor, microprocessor, an application specific integrated circuit (ASIC), a field programmable gate array (FPGA) or the like. Processing logic 320 may execute software instructions/programs or data structures to control operation of electronic device 140 and/or components within electronic device 140. Implementations of electronic device 140 may use an individual processing logic component or multiple processing logic components (e.g., multiple processing logics 320), such as processing logic components operating in parallel.

Memory 330 may include a random access memory (RAM) or another type of dynamic storage device that stores information and instructions for execution by processing logic 320; a read only memory (ROM) or another type of static storage device that stores static information and instructions for use by processing logic 320; a flash memory (e.g., an electrically erasable programmable read only memory (EEPROM)) device for storing data and/or instructions; and/or some other type of magnetic or optical recording medium and its corresponding drive. Memory 330 may be used to store video and/or other information received through communication interface 360. Memory 330 may also be used to store temporary variables or other intermediate information during execution of instructions by processing logic 320. Instructions used by processing logic 320 may also, or alternatively, be stored in another type of computer-readable medium accessible by processing logic 320. A computer-readable medium may include one or more logical or physical memory device.

Input device 340 may include a mechanism that permits a user to input information to electronic device 140, such as microphone 260, keypad 250, control buttons 240, a touch screen, a keyboard, a gesture-based device, an optical character recognition (OCR) based device, a joystick, a virtual keyboard, a speech-to-text engine, a mouse, a pen, voice recognition and/or biometric mechanisms, etc. Output device 350 may include a mechanism that outputs information to the user, including a display, such as display 230, a printer, one or more speakers, such as speaker 220, etc.

Communication interface 360 may include any transceiver-like mechanism that enables electronic device 140 to communicate with other devices and/or systems. For example, communication interface 360 may include mechanisms for communicating via a network, such as a wireless network. Communication interface 360 may include one or more radio frequency (RF) transmitters, receivers and/or transceivers and one or more antennas for transmitting and receiving RF data in multiple frequency bands, including, for example, a wide area cellular telephone network (such, e.g., as a 3G network) and a digital video broadcasting network (such as DVB-H). Communication interface 360 may also include a modem or an Ethernet interface to a LAN.

Power supply 370 may include one or more power supplies that provide power to components of electronic device 140. For example, power supply 370 may include one or more batteries and/or connections to receive power from other devices, such as an accessory outlet in an automobile, an external battery, or a wall outlet. Power supply 370 may also include metering logic to provide the user and components of electronic device 140 with information about battery charge levels, output levels, power faults, etc.

As will be described in detail below, electronic device 140, consistent with the principles described herein, may perform certain operations relating to receiving web feeds over DVB-H in response to user inputs or in response to processing logic 320. Electronic device 140 may perform these operations in response to processing logic 320 executing software instructions of a display configuration/reprogramming application contained in a computer-readable medium, such as memory 330. The software instructions may be read into memory 330 from another computer-readable medium or from another device via communication interface 360. The software instructions contained in memory 330 may cause processing logic 320 to perform processes that will be described later. Alternatively, hardwired circuitry may be used in place of or in combination with software instructions to implement processes consistent with the principles described herein. Thus, implementations consistent with the principles of the embodiments are not limited to any specific combination of hardware circuitry and software.

FIG. 4 is a functional block diagram of exemplary components that may be included in electronic device 140. As shown, electronic device 140 may include a user digital broadcast receiver module 410, a web feed cache 415, a web feed reader 420, a web feed settings manager 430, a web browser 440, and display logic 450. In other implementations, electronic device 140 may include fewer, additional, or different types of functional components than those illustrated in FIG. 3 (e.g., a touch panel controller). Each of the functional components may be implemented as hardware, software operating on hardware, firmware, or the like.

Digital broadcast receiver module 410 may receive an IP stream containing IP packets from a network, such as DVB-H network 130 of FIG. 1. Some of the IP packets may include web feed(s) on a designated port. Digital broadcast receiver module 410 may decrypt, demultiplex, and parse the IP packets to allow them to be assembled as files.

Web feed cache 415 may include any mechanism capable of storing IP data packets and/or web feed files. For example, buffer 415 may be a memory, such as a random access memory (RAM), and may include a memory size capable of storing a frame, a partial frame (e.g., a field), and/or some sort of block size. In one implementation, web feed cache 415 may store web feed files that have not been viewed by a user. In another implementation, packets that do not form a complete web feed may be sent to web feed cache 415 until sufficient packets are collected to assemble a complete web feed.

Web feed reader 420 may read and execute software instructions/programs to format web feeds received at electronic device 140 for presentation to a user. Web feed reader 420 may communicate with display logic to present information from a web feed on a display (such as display 230) of electronic device 140. Web feed reader may also interpret information in web feed files to present options for user input, such as links to web sites or DVB-H television programming embedded in a web feed file.

Web feed settings manager 430 may read and execute software instructions/programs to configure user preferences for reception of web feeds received at electronic device 140. For example, web feeds settings manager 430 may communicate with display logic 450 and user input device 340 to solicit and receive user settings. Web feed settings may include the intervals at which web feed updates may be presented and/or particular tags in a web feed that may trigger presentation of a web feed. Other setting may include default web feed display formats to be used by web feed reader 420 and memory management.

Web browser 440 may read and execute software instructions/programs to display web content. Web browser 440 may be, for example, a mobile browser designed for use on a mobile device, such as electronic device 140. Web browser 440 may communicate with web feed reader 420 to retrieve full content for items in the web feed that are requested by a user (e.g., a user may select a hyperlink in the web feed). Is some implementations, web browser 440 may be combined with web feed reader 420.

Display logic 450 may include processing logic to interpret signals and instructions and a display device (such as display 230) having a display area to provide information to a user of electronic device 140. Implementations of display logic 450 may display information from web feeds and other DVB-H files, including still images (e.g., photographs), moving images (e.g., video), text, numbers, symbols, graphical elements, etc. to a user of electronic device 140. Implementations of display logic 450 may include mediums that change properties as light passes through the mediums, or display logic 450 may include mediums that reflect light.

### Exemplary Frame Structure

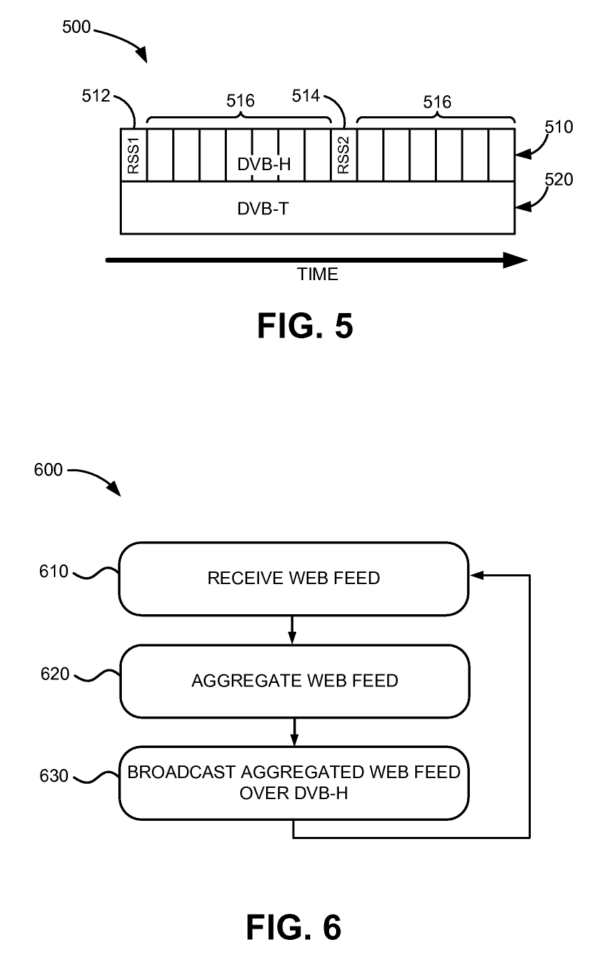

FIG. 5 is a schematic illustrating an exemplary DVB-H frame structure 500 for broadcasting web feeds. A DVB-H broadcast stream 510 is shown associated with a DVB-T (Digital Video Broadcasting-Terrestrial) broadcast stream 520 to illustrate the time-slicing nature of DVB-H protocol. Web feed file RSS1 512 may be included in a DVB-H burst. Web feed file RSS1 512 may be a complete web feed file or a portion of a file. At a later point in time, another web feed file RSS2 514 may be included in another DVB-H burst. Web feed file RSS2 514 may be a complete web feed file or another portion of a web feed file RSS1 512. For example, web feed file RSS1 512 may include a web feed for a particular subscription (e.g., “general news”) with a particular encryption code. Web feed file RSS2 514 may include a different web feed for a different subscription (e.g., “Premiere League football”) with a different encryption code. In between web feed file RSS1 512 and web feed file RSS2 514 other DVB-H bursts 516 may be transmitted that include other programming content, such as television broadcasts, that may not be relevant to the web feeds.

### Exemplary Operations

FIG. 6 is a flow diagram 600 illustrating exemplary operations associated with broadcasting web feeds over DVB-H. The operations may be performed by an aggregator, such as aggregator 120 of FIG. 1 in conjunction with a DVB-H network, such as DVB-H network 130 of FIG. 1. The web feeds may be originally provided by, for example, content providers, such as content provider(s) 110 of FIG. 1.

A web feed may be received (block 610). For example, a content provider, such as content provider 110, may provide a web feed to aggregator 120. In one implementation, the web feed may include basic information about content provider 110 and dynamic information about new information available at content provider 110 (such as a title, a particular universal resource locator (URL), and/or a brief description). In another implementation, the web feed may include information to allow electronic device 140 to identify the channel of other media content that is also being broadcast over DVB-H.

The web feed may be aggregated (block 620). For example, aggregator 120 may combine the web feed received in block 610 with other web feeds or other information to be broadcast. In one implementation, the web feed may be aggregated with web feeds received from other content providers within a particular time interval. In another implementation, the web feed may be grouped with other web feeds in a particular category (such as general news, weather, sports, financials, etc.). A single file for the aggregated web feeds may be created. The aggregated file may retain the format of the original web feed (e.g., RSS), or the aggregated file may be reformatted into another proprietary or non-proprietary format for use on a recipient electronic device, such as electronic device 140.

The aggregated file may be broadcast via DVB-H (block 630). For example, DVB-H network 130 may broadcast the aggregated file so that the aggregated file may be received by recipient devices, such as electronic device 140. In one implementation, the aggregated file may be encrypted (using, for example, an access key previously provided to subscribers) prior to the broadcasting of the aggregated file. The aggregated file broadcast may also include keys for subscribing devices to decrypt future broadcasts of aggregated files. In one implementation, the aggregated file may include a web feed that is associated with other media content currently being broadcast, such as a newscast or live-event broadcast also being broadcast via DVB-H.

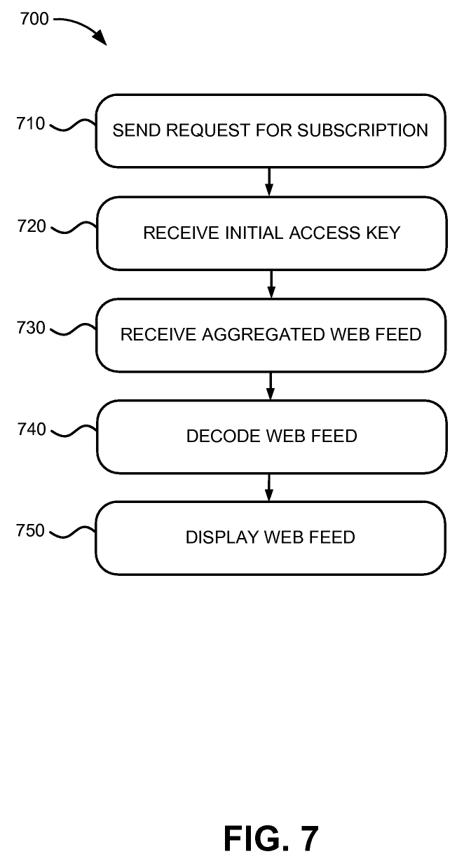

FIG. 7 is a flow diagram 700 illustrating exemplary operations associated with receiving broadcast web feeds via DVB-H. The operations may be performed, for example, by an electronic device, such as electronic device 140 of FIG. 1. The web feeds may be broadcast, for example, via DVB-H network 130 to the electronic device.

A subscription request may be sent (block 710). For example, a user of electronic device 140 may subscribe to a DVB-H web feed service. In one implementation, the subscription request may be sent from electronic device 140 to a service provider within mobile network 150. In another implementation, the subscriber may subscribe to services by communicating outside of the system 100 environment (e.g., using a standard telephone or internet connection) with an operator of aggregator 120 or the service provider in mobile network 150. The web feed subscription may be included as part of a mobile TV service subscription. In another implementation, a user of electronic device 140 may subscribe for a particular category (or channel) of web feeds from a selected group (e.g., general news, weather, sports, financials, etc.).

An initial access key may be received (block 720). For example, an initial access key to decrypt DVB-H data within the scope of a subscriber's subscription may be provided to electronic device 140. The initial access key may be, for example, in the form of a code word or message provided specifically to electronic device 140. The initial access key may be used, for example, to decrypt DVB-H data or to decrypt subsequent decryption keys that may be used to decrypt DVB-H data. The initial access key may, for example, be provided to electronic device 140 via mobile network 150, while subsequent keys may be provided via DVB-H network 130.

An aggregated web feed file may be received (block 730). For example, electronic device 140 may receive a web feed file as part of a DVB-H broadcast from DVB-H network 130.

The web feed file may be decoded (block 740). For example, electronic device 140 may use the initial access key (or a subsequently-received key) to decrypt, process, decode, and assemble the web feed file.

The web feed file may be displayed (block 750). For example, electronic device 140 may display the web feed in a manner consistent with a user configuration or a default setting on electronic device 140. In one implementation, an indication that a new web feed has been received may be presented on a display of electronic device 140 or may be provided as a ringtone or other indication. The user may then view the web feed at the user's convenience.

### Example

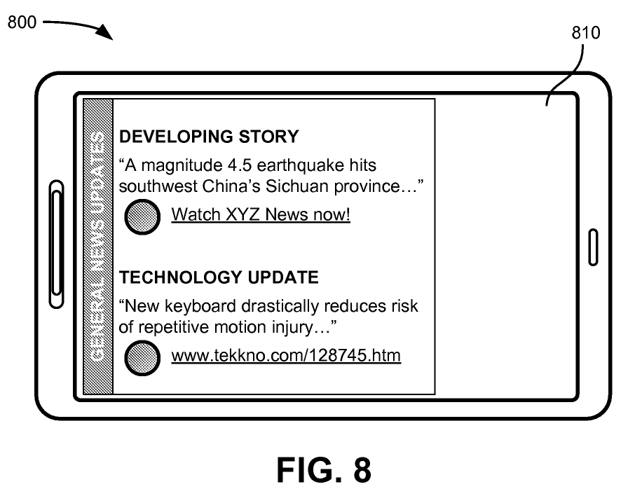

FIG. 8 provides an illustration of an exemplary implementation of the operations of FIG. 7. As shown in FIG. 8, a user device 800 may include a display 810. Display 810 may be a touch screen display that allows a user to interact with information shown. Other components, such as control buttons, a keypad, a microphone, connectivity ports, and/or memory slots may be located on electronic device 800. User device 800 may receive a “General News Updates” web feed over DVB-H for which a user has subscribed along with general TV viewing access over DVB-H. Electronic device 800 may use an access key to decrypt, process, decode, and assemble the web feed file. A web feed reader, for example, may then display the file on display 810.

In the example of FIG. 8, the web feed includes two updates from different content providers. The first update, titled “Developing Story,” is from “XYZ News” reporting indications of an earthquake. The web feed includes a link with the heading “Watch XYZ News now!”. In one implementation, the web feed reader of electronic device 140 may be configured to allow a user to select the link and automatically initiate a DVB-H-enabled media session for the XYZ News television program. In another implementation, the link may be presented in the form of a widget proving instruction to electronic device 140. Upon selecting the icon for the “Watch XYZ News now!” link the user may begin viewing the XYZ News television program that is currently being broadcast over the DVB-H.

The second update, titled “Technology Update,” is from the website www.tekkno.com reporting about a new keyboard. The web feed includes a link to the full article at www.tekkno.com that is associated with the new keyboard. In one implementation, the web feed reader of electronic device 140 may be configured to allow a user to select the link and automatically launch a web browser. In another implementation, the link may be presented in the form of a widget proving instruction to electronic device 140. Upon the user's selecting the icon for “www.tekkno.com/128745.htm,” electronic device 800 will activate a web browser application to retrieve the article at the website.

### Conclusion

Implementations described herein may distribute web feeds and other information to electronic devices over a DVB-H network. Web feeds may be provided by content providers and broadcast over the DVB-H network. Electronic devices having a DVB-H receiver and (in some cases) a decryption key may receive the web feeds without use of a two way mobile connection. Use of a DVB-H broadcast may thus reduce signaling required from the electronic device.

The foregoing description of the embodiments described herein provides illustration and description, but is not intended to be exhaustive or to limit the invention to the precise form disclosed. Modifications and variations are possible in light of the above teachings or may be acquired from practice of the invention.

For example, implementations have been mainly described in the context of a DVB-H broadcast network. These implementations, however, may be used with alternative networks for providing live television services on a handheld device, such as DMB, ISDB-T, MediaFLO and DVB-SH. As another example, while the DVB-H and the mobile networks have generally been depicted as separate networks, in other implementations, the same network may be used to perform the operations described herein (using, for example, different protocols).

Also, while implementations described herein have been described in the context of distributing web feeds, other implementations may include use of DVB-H to distribute information to widgets, such as mobile widgets for cellular phones. In still other implementations, web feeds over DVB-H may be broadcast without encryption, allowing any electronic device with a DVB-H receiver to receive the web feeds.

Further, while a series of blocks has been described with respect to FIGS. 6 and 7, the order of the blocks may be varied in other implementations. Moreover, non-dependent blocks may be performed in parallel.

Aspects described herein may be implemented in methods and/or computer program products. Accordingly, aspects may be embodied in hardware and/or in software (including firmware, resident software, micro-code, etc.). Furthermore, aspects described herein may take the form of a computer program product on a computer-usable or computer-readable storage medium having computer-usable or computer-readable program code embodied in the medium for use by or in connection with an instruction execution system. The actual software code or specialized control hardware used to implement these aspects is not limiting. Thus, the operation and behavior of the aspects were described without reference to the specific software code-it being understood that software and control hardware could be designed to implement the aspects based on the description herein.

Further, certain aspects described herein may be implemented as “logic” that performs one or more functions. This logic may include firmware, hardware-such as a processor, microprocessor, an application specific integrated circuit or a field programmable gate array—or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

What is claimed is:

1. A method comprising:
receiving, at a device having a digital video broadcast receiver, an initial access key for a digital video broadcast-handheld (DVB-H) broadcast;
receiving a web feed file, the web feed file being provided over a DVB-H network;
decoding the web feed file based on the initial access key; and
displaying the web feed file on a display.

2. The method of claim 1, where the web feed file comprises a link to a web site associated with information in the web feed file and where the method further comprises:
accessing the link to the web site using a mobile network.

3. The method of claim 1, where the web feed file comprises information for a television program associated with the web feed file and where the method further comprises:
displaying the television program.

4. The method of claim 1, where displaying the web feed file includes presenting a user with an option to access additional information related to the web feed.

5. The method of claim 1, where the web feed file includes a tag, and where the method further comprises:
reading the tag on the web feed file; and
determining to display the web feed file based on the tag.

6. The method of claim 1, where the initial access key is provided over a mobile network.

7. The method of claim 1, where the web feed is an aggregated web feed file that includes web feeds from multiple content providers.

8. The method of claim 1, further comprising:
broadcasting the web feed file together with a television program related to the web feed file.

9. The method of claim 1, further comprising:
broadcasting data over the DVB-H network at a particular time period based on a request from the device, the request being provided via a mobile network connection.

10. A method comprising:
receiving a web feed from a content provider;
aggregating the web feed with information from other content providers;
encrypting the aggregated web feed; and
broadcasting the encrypted aggregated web feed over a digital video broadcast-handheld (DVB-H) network.

11. The method of claim 10, further comprising:
sending an initial access key to a subscriber's device, the initial access key including information to decrypt the encrypted aggregated web feed.

12. The method of claim 10, further comprising:
broadcasting a decryption key to a subscriber's device, the decryption key including information to decrypt a future encrypted aggregated web feed.

13. The method of claim 10, further comprising:
associating the web feed with a television program being broadcast over the DVB-H network.

14. The method of claim 10, further comprising:
notifying a subscriber's device of a particular time period when the aggregated web feed will be broadcast over the DVB-H network; and
broadcasting the aggregated web feed during the particular time.

15. The method of claim 10, further comprising:
receiving a subscription request for a subscriber's device to receive the aggregated web feed.

16. The method of claim 10, where aggregating the web feed with other information comprises collecting web feeds from multiple content providers within a particular time period.

17. A device comprising:
a digital broadcast receiver module to receive a web feed over a digital video broadcast-handheld (DVB-H) network,
a web feed reader to format information in the web feed;
a display to present the formatted information in the web feed to a user; and
processing logic to accept a user input and to retrieve additional information related to the web feed based on the user input.

18. The device of claim 17, where the user input is a selection of a web site and the additional information is retrieved through a mobile network.

19. The device of claim 17, where the user input is a selection of a television program and the addition information is retrieved from a DVB-H broadcast.

20. The device of claim 17, where the web feed is encrypted and the device further comprises:
processing logic to decrypt the encrypted web feed based on a decryption key.
